(19) United States
(12) Patent Application Publication
(10) Pub. No.: US 2005/0193763 A1
(43) Pub. Date: Sep. 8, 2005

(54) Multi-stage no-oil gas compressor

(75) Inventors: Adrian Alford, Twyford (GB); Gerd Wilhelm Cromm, Dortmund (DE); Julian Oliver Reed, Surrey (GB)

Correspondence Address: FLEIT, KAIN, GIBBONS, GUTMAN, BONGINI;& BIANCO P.L., ONE BOCA COMMERCE CENTER, 551 NORTHWEST 77TH STREET, SUITE 111, BOCA RATON, FL, 33487, US

(73) Assignee: Corac Group PLC, Uxbridge (GB)

(21) Appl. No.: 11/073,232

(22) Filed: Mar. 4, 2005

(30) Foreign Application Priority Data
Mar. 5, 2004 (GB) 0404948.2
Nov. 23, 2004 (GB) 0425734.1

(51) Int. Cl. B01D 8/00; F25D 23/12; F25B 1/10

(52) U.S. Cl. 62/510; 62/259.4

(57) ABSTRACT

A multi-stage compressor comprises a variable speed electrically driven rotodynamic compressor stage connected in series with and upstream of a water lubricated screw compressor stage and an intercooler arranged between the two compressors to reduce the temperature of gas entering the screw compressor stage. In the invention, the intercooler is a water spray intercooler, the water supply of which is shared with that of the water lubricated screw compressor.

### CROSS-REFERENCE TO RELATED APPLICATIONS

This application is based upon and claims priority from prior Great Britain Patent Application No. 0404948.2, filed on Mar. 5, 2004 which is based on Great Britain Patent Application No. 0425734.1 filed on Nov. 23, 2004, each of which is hereby incorporated by reference in its entirety.

### FIELD OF THE INVENTION

The present invention generally relates to gas compressors and more practically to a multi-stage no-oil gas compressor with an intercooling arrangement.

### BACKGROUND OF THE INVENTION

There are many techniques available to compress gases and each has its merits in terms of the total pressure rise, the volume flow rate that can be achieved and the efficiency at which the process can operate.

A rotodynamic compressor, which term includes axial flow compressors and centrifugal compressors, achieves gas compression by using a high speed rotor to increase the momentum of the gas, the momentum being converted to a pressure head. This type of machine is ideal when a high volumetric flow is required with relatively low inlet pressure. To increase the outlet pressure, higher rotational speeds are required which can become difficult to achieve while maintaining an acceptable efficiency relative to other approaches. These machines can generally be considered oil free machines as the working elements are not in contact with oil lubricants. This is important for processes that require pure air, such as chemical and food related industries where any oil contamination can affect the main process.

Another known form of compressor is the positive displacement screw compressor which compresses a volume of gas by driving it through a continually reducing volume between two contra rotating screw profiles. The profile of the screw elements determines the fixed “internal pressure ratio” of the compression stage. However, in this device there is also an element of “external compression” of the gas generated around the discharge port which enables the machine to significantly increase the compression ratio.

To help seal the system, lubricate the contacting surfaces and take away heat from the compression process, the screw mesh may be lubricated with oil or water, this liquid eventually being recovered later in the process.

To remove any oil effectively from the air requires significant investment and maintenance of filtering systems. The major benefit of water lubricated screw compressors is that water is not generally considered as a contaminant, is easily removed and environmentally friendly.

The term water lubricated compressor is used herein to refer both to a water injected compressor and a water flooded compressor. The difference between these two is that in a water lubricated compressor, water is introduced into the compressor separately from the process gas whereas in a water-flooded compressor the water is introduced into the compressor mixed in with the process gas. The water injection enables near isothermal compression of the gas to take place, resulting in a highly efficient compression stage. To this end, most water lubricated compressors have a closed loop water circuit, including reverse osmosis and filtration to condition the water, to continuously lubricate and cool the compression elements and the compressed gas flow simultaneously.

The combination of two fundamentally different compressor systems to optimize the performance of the coupled arrangement has been understood for some years, as described in Great Britain patent application 2 034 818, although the technology at that time was orientated around large centrifugal compressors, generating up to 50,000 m3/h of compressed gas. Conventional intercooler and aftercooler arrangements were used to reduce the temperature of the lower pressure gas before it entered the subsequent stage or exited the system. These typically take the form of shell and tube heat exchangers with an external supply of water passing through the tube sections and taking away the heat of compression. The conventional heat exchangers exhibit a pressure drop in the system unless they are substantially oversized, whereupon they become prohibitively expensive. They therefore present a source of poor efficiency and are a substantial component of the overall cost of the machine.

In both cases, to achieve higher pressures, more compression stages can be introduced and two stages are typical. In the case of screw compressors, because of the nature and complexity of the screw profile, the size of the compressor is limited by the machining accuracy achievable that ensures low leakage and high compression efficiencies. This makes screw compressors less suitable for high volume flows. Conversely, for centrifugal machines, large volume flows and hence sizes are preferred. Difficulties occur at small volumes where smaller machines are required that run at increasingly higher rotational velocities to ensure adequate momentum exchange. This presents balancing and bearing related problems as balancing accuracies need to be increased and speeds can be in excess of conventional bearing capabilities.

Accordingly what is needed is a no-oil gas compressor to over come the problems encountered in the prior art and to avoid the use of bulky heat exchangers.

### SUMMARY OF THE INVENTION

Accordingly, to the present invention, there is provided a multi-stage compressor comprising a variable speed electrically driven rotodynamic compressor first stage, a water lubricated screw compressor second stage connected in series with and downstream of the rotodynamic compressor stage, and an intercooler arranged between the two stages to reduce the temperature of gas entering the screw compressor stage, wherein the intercooler is a water spray intercooler which shares a common water supply with the water lubricated screw compressor stage, and the discharged gas and water from the intercooler flow directly into the screw stage.

The invention combines the benefits of each type of no oil compressor configuration into one unit, exploiting the potential compactness of a high speed electrically driven rotodynamic compressor first stage with a screw compressor element second stage, as has been previously disclosed. The high speed rotodynamic stage can provide a high volumetric flow in a relatively compact arrangement, thus making it suitable for the inlet stage, whereas the screw stage has the ability to accommodate variable inlet conditions with it remaining able to achieve constant pressure delivery. In a comparable two stage screw machine, the inlet stage is large and bulky and its substitution with a high speed rotodynamic unit offers cost as well as performance benefits.

This invention proposes to utilize water to cool the gas directly via a spray cooler system. In this instance, water is injected via spray nozzles into the gas stream exiting the first centrifugal stage compressor. By using this approach, high thermal exchange rates can be achieved with negligible pressure drop, as the gas is in intimate contact with the water. The absence of plates and tubes in the intercooling stage eliminates any thermal resistance from this part of the process. It also reduces cost, complexity and size.

The main significance of this arrangement is that the subsequent screw stage can accept a gas/water mixture, which can result in a further compression efficiency improvement. By adopting this approach, a proportion of the water is effectively introduced into the screw at inlet. While in a water-flooded screw compressor, the whole of the water can be introduced in this manner, in the preferred embodiment of the invention the proportion is about one half and the remainder is injected at some intermediate point in the compression process within the screw. This is preferred because it has the effect of introducing the liquid when it is needed rather than all at one position.

By careful regulation of the water flow rates and droplet size of the spray, the heat of compression is accepted by the water.

In a preferred embodiment, the invention proposes the use of a variable speed high speed centrifugal stage in combination with a conventional fixed speed water lubricated screw compression stage (although a variable speed second stage may be accepted).

Water lubricated screw compressors require a water filtration and purification process to ensure deposits and fines do not build up in the machine. The closed loop water levels may be added to or detracted from by varying humidity levels in the compressed gas. Therefore most conventional compressors of this type have a make up and drain off system that continuously conditions the water present in the machine. The spray intercooling stage is therefore compatible with this requirement and the system can readily be extended to accommodate this additional feature.

The presence of water in the water lubricated screw stage obviates the need for an aftercooler. The gas exiting the screw stage is nominally at 50° C. and a simple centrifugal separator and refrigerant drier ensures that all the water can be recovered and the delivered gas is free of contaminants and particularly oil free.

The foregoing and other features and advantages of the present invention will be apparent from the following more particular description of the preferred embodiments of the invention, as illustrated in the accompanying drawings.

### BRIEF DESCRIPTION OF THE DRAWINGS

The subject matter, which is regarded as the invention, is particularly pointed out and distinctly claimed in the claims at the conclusion of the specification. The foregoing and other features, and advantages of the invention will be apparent from the following detailed description taken in conjunction with the accompanying drawings in which:

FIG. 1 is a The invention will now be described further, by way of example, with reference to the accompanying drawing which shows schematically a two stage compressor of the present invention.

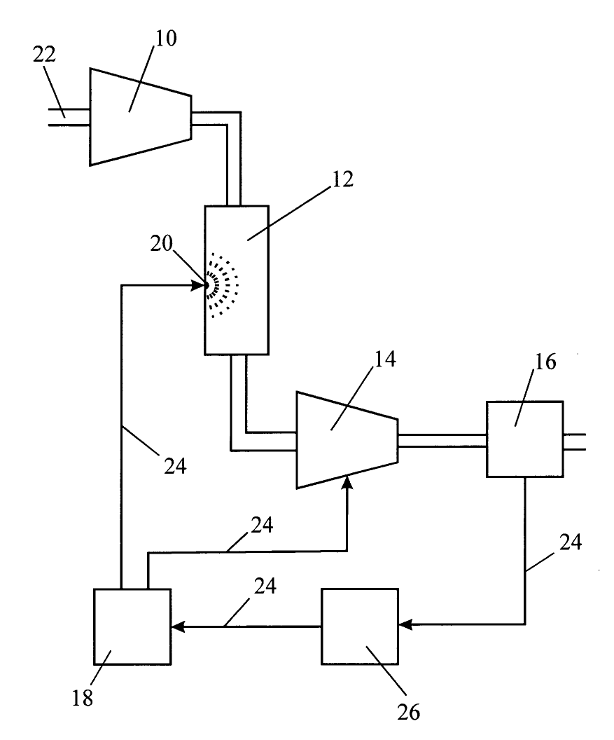

### DESCRIPTION OF THE PREFERRED EMBODIMENTS

It should be understood that these embodiments are only examples of the many advantageous uses of the innovative teachings herein. In general, statements made in the specification of the present application do not necessarily limit any of the various claimed inventions. Moreover, some statements may apply to some inventive features but not to others. In general, unless otherwise indicated, singular elements may be in the plural and vice versa with no loss of generality.

In the single figure, the conduits along which gas flows are represented by double lines whereas the pipes, numbered 24, that carry water are shown as single lines.

Gas to be compressed enters at 22 into an electrically driven centrifugal compressor 10. Once compressed by the centrifugal compressor 10, the hot gas flows through a water spray intercooler 12.

The water spray intercooler 12 is effectively a canister which slows down the gas. At the same time, water is injected at high pressure into the canister through nozzles or jets 20. These cause the water to atomize into a fine mist which cools down the now slower traveling gas giving the water more time to absorb heat from the gas. The water flow rates and droplet size of the spray in the intercooler are regulated in order to ensure the heat of compression of the gas is accepted by the cooling water. This method of cooling avoids the use of heat exchangers which are bulky, expensive, introduce a pressure drop and are susceptible to damage by virtue of their use of thin metal fins and propensity to blockages due to the accumulation of scales and other chemical deposits.

In the next stage of the process, the cooler high pressure gas enters the inlet port of a water lubricated screw compressor 14 where it is further compressed. Screw type compressors such as this, consist of two counter rotating intermeshing screws. As they turn gas trapped between them is forced down the length of the screws, the further along the screw the gas is pushed, the greater the compression. If, as illustrated, the water lubricated compressor 14 is of the water injected type, water is injected under pressure from a conditioning unit 18 at some intermediate point along the screw in order to cool the gas as it is heated by the compression process. If a water flooded screw compressor is used, then all the water enters with the process gas and the pipe leading to the compressor 14 from the conditioning unit 18 is not required.

In many applications which require the use of such a compressor, it is important for the water to be free of impurities such as minerals and any particles which may promote growth of bacteria.

In the illustrated embodiment of the invention, the water which interacts directly with the gas stream remains within a closed loop defined by the water pipes 24 and air lines pre and post screw compressor 14 and separator 16. In particular, upon being discharged from the screw compressor 14, the gas passes through the separator 16 in order to separate the majority of water from the gas for recycling. The separated water is cooled by a heat exchanger 26, to extract from it the heat absorbed from the gas during the intercooling and compression processes and it is passed through the conditioning unit 18 before it is recycled to the intercooler 12 and, where necessary, to the screw compressor 14. Cooling of the water within this closed loop may be achieved by conventional external water or coolant circulation systems which may include blast coolers, cooling towers or even river water passing through the heat exchanger 26.

The illustrated system provides water from the same water supply 18 both to the intercooler spray nozzles 20 and the working elements of the screw compressor 14. The pressure used to drive the water out of the water spray intercooler nozzles 20 and into the screw compressor is provided by the pressure of the gas at the outlet of the screw compressor 14.

Although a specific embodiment of the invention has been disclosed, it will be understood by those having skill in the art that changes can be made to this specific embodiment without departing from the spirit and scope of the invention. The scope of the invention is not to be restricted, therefore, to the specific embodiment, and it is intended that the appended claims cover any and all such applications, modifications, and embodiments within the scope of the present invention.

1. A multi-stage compressor comprising:
a variable speed electrically driven rotodynamic compressor first stage;
a water lubricated screw compressor second stage connected in series with and downstream of the rotodynamic compressor stage; and
an intercooler arranged between the first stage and the second stage to reduce a temperature of gas entering the second stage;
wherein the intercooler is a water spray intercooler which shares a common water supply with the water lubricated screw compressor stage, and
wherein a discharged gas and water from the intercooler flow directly into the second stage.

2. The multi-stage compressor of claim 1, wherein the first stage comprises a high speed centrifugal compressor.

3. The multi-stage compressor of claim 2, wherein the second stage is a fixed speed water injected screw compressor.

4. The multi-stage compressor of claim 2, wherein the second stage is a variable speed water injected screw compressor.

5. The multi-stage compressor of claim 1, further comprising a separator for removing substantially all the water from the gas discharged from the second compressor stage.

6. The multi-stage compressor of claim 5, wherein the common water supply draws water from the separator and includes a conditioning unit.

7. The multi-stage compressor of claim 1, wherein a rate of water flow and a size of a droplet in a spray from the intercooler are regulated in order to ensure a heat of compression of the gas is accepted by the cooling water.
